(19) United States
(12) Patent Application Publication
(10) Pub. No.: US 2025/0156760 A1
(43) Pub. Date: May 15, 2025

(54) SYSTEM FOR ENHANCED TASK-SPECIFIC LANGUAGE MODEL GENERATION THROUGH DYNAMIC ADAPTERS AND CONTEXTUAL DATA RETRIEVAL

(71) Applicant: Highwater Labs Inc., Plano, TX (US)

(72) Inventors: Chase Quenton Aucoin, Kansas City, MO (US); Jason Keith Patz, Plano, TX (US)

(21) Appl. No.: 18/942,119

(22) Filed: Nov. 8, 2024

Related U.S. Application Data
(60) Provisional application No. 63/597,770, filed on Nov. 10, 2023.

(51) Int. Cl. G06N 20/00; G06F 9/445; G06F 9/48

(52) U.S. Cl. CPC G06N 20/00; G06F 9/44521; G06F 9/4881

(57) ABSTRACT

The present disclosure relates to a system for dynamic task processing using a core language model and task-specific models. The system comprises a memory, a persistent storage, and a core model that resides in memory. A plurality of task-specific models are stored in persistent storage and configured to be dynamically loaded into and unloaded from memory in real-time based on incoming task requests. Upon receiving a task request, a corresponding task-specific model is loaded into memory and integrated as an additional layer of the core model to fine-tune its output for the specified task.

### CROSS-REFERENCE TO RELATED APPLICATION

The present application claims priority to U.S. Provisional Application No. 63/597,770, filed on Nov. 10, 2023, and titled “SYSTEM FOR ENHANCED TASK-SPECIFIC LANGUAGE MODEL GENERATION THROUGH DYNAMIC ADAPTERS AND CONTEXTUAL DATA RETRIEVAL.” The entire contents of the above-identified application is incorporated herein by reference.

### TECHNICAL FIELD

The present disclose relates generally to the field of artificial intelligence and machine learning, and, more particularly, some embodiments relate to systems and methods for generating and utilizing task-specific language models for automated processes.

### BACKGROUND

Advancements in artificial intelligence (AI), particularly in generative language models, have significantly altered the potential applications of such technology in various industries. Open AI's introduction of ChatGPT has been a development in the field, enabling the generation of coherent and contextually relevant textual outputs over extended passages. GPT refers to a generative pre-trained transformer, which is a type of a large language model (LLM) neural network that can perform various natural language processing tasks. Conventional language models struggled with maintaining coherence and relevance over longer text spans, often producing nonsensical or tangent-heavy content.

The present disclose improves upon the conventional approaches by addressing the limitations of large, generalized models through introducing a system capable of generating and managing smaller, task-specific language models that provide more focused and precise outputs for specialized tasks.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 depicts an example schematic block diagram of a high-level architecture, in accordance with embodiments of the present disclosure.

FIG. 2 depicts an example schematic block diagram of a training architecture, in accordance with embodiments of the present disclosure.

FIG. 3 depicts an example schematic block diagram of a data management architecture, in accordance with embodiments of the present disclosure.

FIG. 4A depicts an example schematic block diagram of a coordination architecture, in accordance with embodiments of the present disclosure.

FIG. 4B depicts an example system diagram of the EnterpriseGPT model with multi-layer adapters, in accordance with embodiments of the present disclosure.

FIGS. 5A and 5B depict an example schematic block diagram of an execution architecture, in accordance with embodiments of the present disclosure.

FIGS. 6A and 6B depict an example process flow of a customer service automation use case, in accordance with an embodiment of the present disclosure.

FIG. 7 is an example computer system that may be used to implement various features of the present disclosure.

The figures are not exhaustive and do not limit the present disclosure to the precise form disclosed.

### SUMMARY

A system of one or more computers can be configured to perform particular operations or actions by virtue of having software, firmware, hardware, or a combination of them installed on the system that, in operation, causes the system to perform the actions. One or more computer programs can be configured to perform particular operations or actions by virtue of including instructions that, when executed by a data processing apparatus, cause the apparatus to perform the actions.

In one general aspect, the system may include a memory. The system may also include a persistent storage. The system may furthermore include a core model that resides in the memory. Additionally, the system may include a plurality of task-specific models that reside in the persistent storage and are dynamically loadable into and unloadable from the memory in real-time in response to incoming task requests. Upon receiving a task request, a corresponding task-specific model is loaded into the memory and integrated into the core model as an additional layer to fine-tune the output of the core model. Other embodiments of this aspect include corresponding computer systems, apparatus, and computer programs recorded on one or more computer storage devices, each configured to perform the actions of the methods.

Implementations may include one or more of the following features. The system where the corresponding task-specific model is unloaded upon completion of the task request. The system where the task-specific models are trained with task-specific training data to fine-tune the output of the core model for a specific task. The weights of the task-specific models use reduced bit-depth representation, and at least one weight tensor of the task-specific models is decomposed as a product of multiple lower-dimensional tensors. The system where the core model may include a standardized Application Programming Interface (API) for the plurality of task-specific models, where the API includes functionalities to load model weights and configurations.

The system may include one or more processors and one or more non-transitory computer-readable memories coupled to the one or more processors and configured with instructions executable by the one or more processors to: receive user-provided input data including a task scenario and variables outlining task-specific requirements and expected outcomes; generate a prompt based on the user-provided input data to a large language model (LLM) for generating a synthetic training dataset using data augmentation and conditional text generation; feed the synthetic training dataset into the core model to obtain intermediate outputs; and fine-tune the intermediate outputs by adjusting parameters of a task-specific model corresponding to the task scenario, where the parameters of the core model remain unchanged.

The system where, to fine-tune the intermediate outputs by adjusting parameters of a task-specific model, the one or more processors are configured to partition the parameters of the task-specific model into pages that are swapped in and out of the memory as needed. The system where the plurality of task-specific models may include one or more of an audio-to-text adapter, a text-to-audio adapter, an image-to-text adapter, or a sensitive data filter adapter. The system where the sensitive data filter adapter is configured as a first processing layer to identify and tokenize user-sensitive data in an input before forwarding it to other task-specific models. The system where the sensitive data filter adapter is further configured to rehydrate outputs from the other task-specific models by replacing tokens with the original sensitive data after processing by the core model and task-specific models. The system where the sensitive data filter adapter is configured to tokenize sensitive data using predefined data patterns and maintain a mapping for rehydration of outputs from the other task-specific models. The system where an interface of the core model is configured to manage memory usage by reference tracking to monitor active usage of the plurality of task-specific models, such that task-specific models with a reference count of zero become candidates for unloading.

The system where the plurality of task-specific models are assigned different priority levels based on their corresponding loading frequencies, where frequently loaded task-specific models are assigned higher priority, and a task-specific model assigned with a higher priority is retained in memory even when not actively in use, ensuring rapid task initiation and reducing the overhead of reloading from persistent storage. The system where the task-specific model assigned a higher priority is unloaded when a memory shortage occurs, freeing resources for other tasks. Implementations of the described techniques may include hardware, a method or process, or a computer tangible medium.

In one general aspect, a computer-implemented method may include storing a core model in memory. The computer-implemented method may also include storing a plurality of task-specific models in persistent storage. The method may furthermore include loading, in real-time, a corresponding task-specific model from the persistent storage into the memory in response to an incoming task request. The method may additionally include integrating the corresponding task-specific model as an additional layer of the core model to fine-tune the output of the core model. The method may also include processing the task request using the core model with the integrated task-specific model to generate a task-specific output. Other embodiments of this aspect include corresponding computer systems, apparatus, and computer programs recorded on one or more computer storage devices, each configured to perform the actions of the methods.

Implementations may include one or more of the following features. The computer-implemented method may include unloading the corresponding task-specific model from the memory upon completion of the task request. The computer-implemented method where each task-specific model is trained using task-specific training data to fine-tune the output of the core model for a specific task, and where the method further includes representing weights of the task-specific models with reduced bit-depth and decomposing at least one weight tensor of the task-specific models as a product of multiple lower-dimensional tensors. Implementations of the described techniques may include hardware, a method or process, or a computer tangible medium.

In one general aspect, a non-transitory computer-readable storage medium may include storing a core model in memory. The non-transitory computer-readable storage medium may also include storing a plurality of task-specific models in persistent storage. The medium may furthermore include loading, in real-time, a corresponding task-specific model from the persistent storage into the memory in response to an incoming task request. The medium may additionally include integrating the corresponding task-specific model as an additional layer of the core model to fine-tune the output of the core model. The medium may also include processing the task request using the core model with the integrated task-specific model to generate a task-specific output. Other embodiments of this aspect include corresponding computer systems, apparatus, and computer programs recorded on one or more computer storage devices, each configured to perform the actions of the methods.

Implementations may include one or more of the following features. The non-transitory computer-readable storage medium where the operations further include unloading the corresponding task-specific model from memory upon completion of the task request. The non-transitory computer-readable storage medium where each task-specific model is trained using task-specific training data to fine-tune the output of the core model for a specific task, and where the operations further include representing weights of the task-specific models with reduced bit-depth and decomposing at least one weight tensor of the task-specific models as a product of multiple lower-dimensional tensors. The non-transitory computer-readable storage medium where the operations further include receiving user-provided input data including a task scenario and variables outlining task-specific requirements and expected outcomes; generating, using a large language model (LLM), a synthetic training dataset based on the user-provided input data, where generating the synthetic training dataset includes data augmentation and conditional text generation; feeding the synthetic training dataset into the core model to obtain intermediate outputs; and fine-tuning the intermediate outputs by adjusting parameters of a task-specific model corresponding to the task scenario, where parameters of the core model remain unchanged during the fine-tuning. Implementations of the described techniques may include hardware, a method or process, or a computer tangible medium.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention. It is to be understood that the foregoing general description and the following detailed description are exemplary and explanatory only, and are not restrictive of the invention, as claimed.

### DETAILED DESCRIPTION

The present disclosure is related to U.S. application Ser. No. 18/327,270, this disclosure of which is incorporated herein in its entirety.

The present disclosure provides a novel system and method for creating, managing, and deploying Quantized Low Rank Adapters (QLoRAs) within a core language model to generate fine-tuned task-specific language models. It addresses the computational and efficiency challenges of large language models by allowing multiple small-scale adapters to be dynamically swapped in and out of memory. This approach enables the generation of high-fidelity outputs for discrete tasks by leveraging a base model that understands the semantics and logic of human language.

In an example embodiment, a system is provided configured for generating and managing task-specific language models through the use of Quantized Low Rank Adapters (QLoRAs). The system can be configured for dynamic management and hot-swapping of QLoRAs to facilitate a range of discrete tasks within a core language model framework.

In an example, a method is provided for dynamic management and hot-swapping of QLoRAs to facilitate a range of discrete tasks within a core language model framework.

In an example, a systems and methods are provided for augmenting language model context with relevant data through managed data connections, enhancing output relevance and accuracy for given tasks.

The embodiments disclosed herein provide for a cutting-edge system that can revolutionize the deployment and utilization of language models in enterprise platforms and other settings. Embodiments disclosed herein can introduce a method of fine-tuning and managing task-specific language models with unprecedented efficiency and specificity, opening up new possibilities for the application of AI in industry-specific tasks.

Additionally, embodiments disclosed herein employs innovative techniques to manage data connections and inject relevant contextual data into the language model's processing, enhancing the accuracy and specificity of the output.

### Overview of System Components:

Core Language Model: A large language model configured to provide a base understanding of human language.

Quantized Low Rank Adapters (QLoRAs): Smaller models that are inserted into the core model as trainable layers to fine-tune the output for specific tasks.

Dynamic Adapter Management: A mechanism for housing multiple adapters in memory and hot-swapping them as needed for different tasks.

Attention Sinks: A technique used to reduce computational load and increase throughput for the system.

Guided Generation: Ensuring that output adheres to specified formats and structures, as dictated by enterprise requirements.

Training Data Generation: A method for creating diverse and robust training datasets from minimal initial examples, enabling the QLoRAs to learn a wide range of scenarios within a specific use case.

Retrieval-Augmented Generation (RAG): A component that manages external data connections and processes for augmenting the language model's context with relevant information.

### Example Steps:

QLoRA Implementation: The process of integrating QLoRAs into the core model, allowing for specialized task performance with reduced computational requirements.

Adapter Management: The unique system for maintaining and dynamically switching between multiple QLoRAs to address specific tasks without the need for large-scale model computations.

Contextual Data Management: The management of data connections and contextual injection, enabling the system to augment the language model's inputs with real-time, relevant data from external sources for improved task performance.

### Example Use Case:

For instance, an application in automotive customer service can leverage a QLORA to diagnose vehicle issues through natural language dialogue. By inputting specifics about car problems and diagnostic scenarios, the system can generate and train on a diverse set of data, creating a focused model capable of guiding customers through troubleshooting procedures.

### Advantages Over Conventional Technology:

Increased Efficiency: By utilizing smaller, more focused models, the system conserves computational resources.

Adaptability: Dynamic adapter swapping allows for flexibility and quick adaptation to a variety of tasks.

Accuracy: Tailored training datasets and attention to detail in data structure ensure precise and relevant outputs.

Scalability: The system's ability to create and manage multiple QLoRAs makes it highly scalable for enterprise applications.

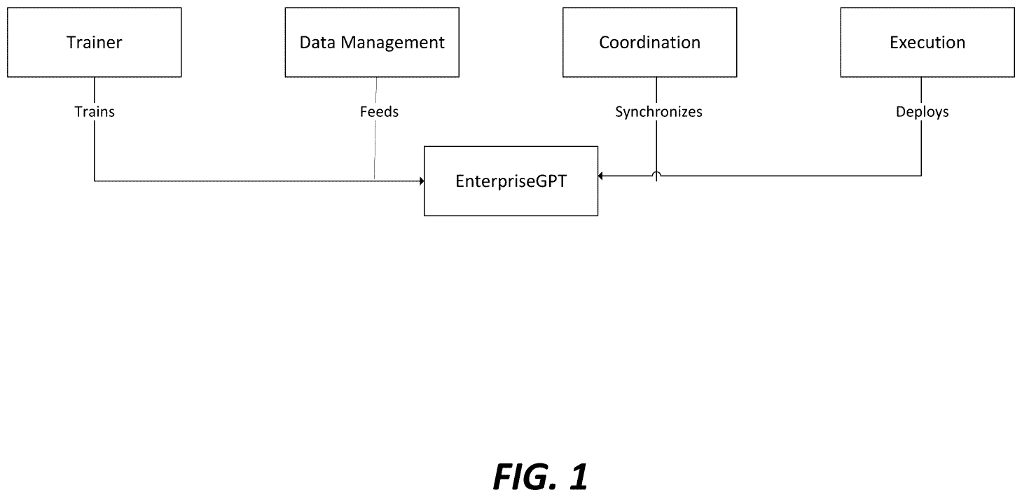

Data Integration: The novel use of RAG to manage and inject contextual data from various sources significantly enhances the model's performance and accuracy. FIG. 1 depicts an example schematic block diagram of a high-level architecture of an EnterpriseGPT system, in accordance with embodiments of the present disclosure. The EnterpriseGPT, according to embodiment disclosed herein, is an advanced AI system designed to generate and manage task-specific language models for a variety of applications. The system is comprised of four main components: Trainer, Data Management, Coordination, and Execution, as shown in FIG. 1. Each component plays a critical role in the system's overall functionality and efficiency.

The Trainer is responsible for creating Quantized Low Rank Adapters (QLoRAs) which are fine-tuned to perform specific tasks. This component leverages a large language model (LLM) to generate training data from a small set of example scenarios and variables provided by the user. In examples disclosed herein, a large LLM, such may consist of 30-80 billion parameters or more, can generate training data based on user-provided examples and variables. The QLoRA training process can utilize the generated training data to produce task-specific QLoRAs. This component can receive user input on example scenarios and a list of variables to guide the training process. Data sources can provide additional information for training data generation. This component may also be configured for model optimization, which implements techniques such as paged optimizers and attention sinks to enhance the training process.

The QLoRAs combines quantization and low-rank approximation to reduce memory footprints and enhance the capabilities of the core language model without significantly increasing computational overhead.

Quantization is a technique used to reduce the precision of the numerical values (weights and activations) within a neural network. In the context of QLoRAs, quantization involves converting the adapter's floating-point weights to lower bit-depth representations, such as 8-bit integers. This reduction in precision decreases the memory footprint and computational requirements of the adapters. By using fewer bits to represent each parameter, the size of the adapter model is significantly reduced, which allows for more efficient storage and faster computations during both training and inference.

Low-Rank Approximation refers to the method of approximating a large tensor (e.g., the weight tensor of a neural network layer) with the product of two smaller tensors. In neural networks, especially transformer-based models, weight tensors can be enormous, containing millions of parameters. By decomposing these large tensors into products of smaller ones with lower rank, the number of parameters needed to represent the layer is greatly reduced. In neural networks, the weight tensor W is approximated by the product of two smaller tensors A and B so that W is approximately equal to A multiplied by B. When the input activation tensor X is passed through the layer, the computation W multiplied by X can be broken down and performed as A multiplied by (B multiplied by X). This decomposition avoids the explicit re-creation of the original weight tensor, which allows for computational efficiency.

Combining these two techniques, QLoRAs achieve a compact representation by approximating the weight matrices with low-rank factors and then quantizing those factors to use lower-precision data types. The result is an adapter that requires substantially less memory and computational power compared to full-sized models or even standard adapters that don't employ these optimizations.

Quantization and low-rank approximation are particularly effective in this system design because each QLoRA is trained to handle a specific type of task with relatively homogeneous training data. For instance, a QLoRA might be specialized in text-to-audio conversion, image-to-text processing, or domain-specific applications such as evaluating the degree of damage to a vehicle using image recognition, managing voice-based billing inquiries, or automatically generating client intake information through conversational interactions.

Since each QLoRA focuses on a narrowly defined task, the variability in the input data is limited compared to general-purpose language models. This homogeneity allows for a significant reduction in the number of parameters or weights required in the adapter. The models do not need to capture the vast complexities of human language in general but only the specific patterns relevant to their designated tasks.

In such specialized contexts, the complexity and variability of the input data of the adapters are limited, allowing the adapters to operate effectively with reduced numerical precision and fewer parameters. Quantization reduces the model's precision without significantly impacting performance because the essential features required for the specific task are still adequately captured. Low-rank approximation further simplifies the model by retaining only the most relevant information, which suffices for the adapter's specialized purpose. This results in lightweight adapters that perform efficiently with minimal computational resources.

In contrast, if a system adopts one generic-purpose model to handle various tasks, the model must handle a vast array of tasks and linguistic patterns, requiring it to model complex, diverse data with high fidelity. Applying quantization and low-rank approximation to these models can lead to a significant loss of crucial information and nuanced understanding. The reduced precision and parameter count may impair the model's ability to capture the full spectrum of language intricacies, resulting in degraded performance across multiple tasks. In other words, the modulization of the task-specific QLoRAs allows the effective application of quantization and low-rank approximation to reduce the memory footprint of the adapters.

Because the adapters are smaller and require less computational power, they can be dynamically loaded and unloaded swiftly, facilitating real-time interaction and adaptability within the system. This efficiency is crucial for applications that demand immediate responses, such as conversational interfaces or image recognition tasks in critical settings.

The Data Management handles the ingestion, indexing, and retrieval of data used by EnterpriseGPT. Data Ingestion may include collecting data from various sources and preparing the data for indexing. Data Indexing may use semantic embedding and reverse indexing strategies to make data retrievable. This component stores indexed data securely and efficiently, for example, in a database or other storage device (e.g., memory). This component may perform data retrieval to fetch and serve data to other components as needed. This component may server data to data endpoints, which may be defined by a user to describe data sources for ingestion.

The Coordination component ensures that multiple task-specific models can work together seamlessly and securely. This component includes a task Coordination Engine, which determines the flow of tasks and manages their execution. A Role-Base Access Control (RBAC) Security Model is also provided that enforces role-based access control to secure data and task interactions. Through data injection, this component can integrate data from the Data Management component into the execution pipeline.

The Execution component is where task-specific QLoRAs are deployed to perform their designated tasks. This component includes an Execution Engine, which orchestrates the execution of tasks using the base language model and QLoRAs. A base language model can be provided that provides for a foundational understanding of language for QLoRAs to build upon. Task-Specific QLoRAs are provided that enhance the base model's output for specific tasks. This component also includes Attention Sinks/Paged Attention, which are techniques used to optimize the performance of the system during execution.

The EnterpriseGPT system architecture of FIG. 1 is designed to provide a scalable, efficient, and secure AI system capable of handling specialized tasks with high precision. Each component, working in concert, assist to deliver a powerful tool for enterprise applications.

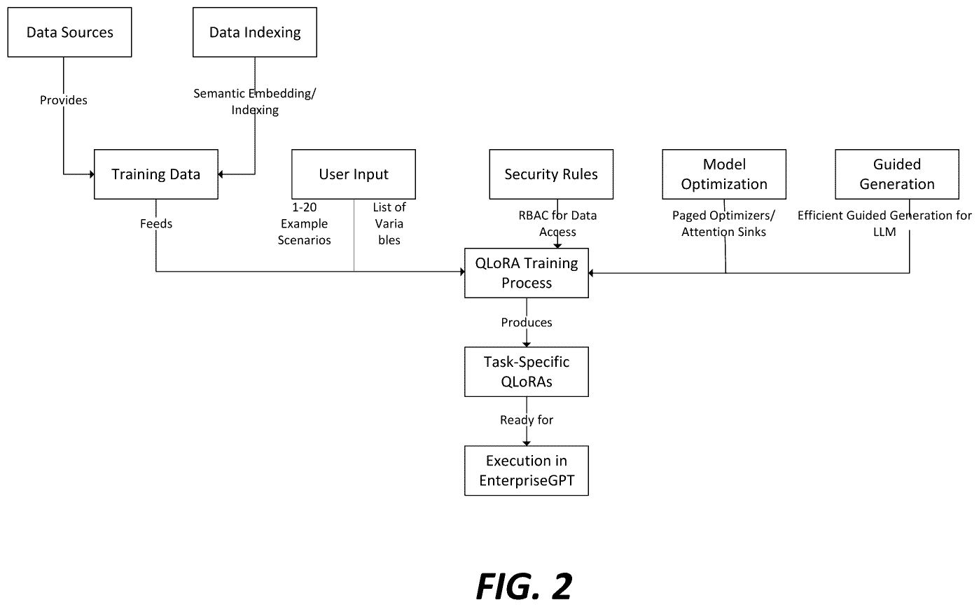

FIG. 2 depicts an example schematic block diagram of a training architecture, in accordance with embodiments of the present disclosure. The Trainer component is a sophisticated subsystem designed for the generation of Quantized Low Rank Adapters (QLORAs). These adapters are specialized modules that fine-tune a base language model to perform discrete tasks with high efficiency and specificity.

The Trainer component initiates the process with Training Data Generation. It begins by accepting user-driven examples, where the user provides between 1 to 20 detailed scenarios that outline the task requirements and expected outcomes, along with a list of relevant variables. These scenarios capture the nuances and complexities of the specific tasks the system is expected to handle, serving as a foundational dataset that reflects real-world situations.

The Trainer then leverages the capabilities of a large language model (LLM) to automatically generate a vast training dataset. Utilizing techniques such as data augmentation and conditional text generation, the Trainer extrapolates from the provided examples to create hundreds of thousands of synthetic training instances. This process is powered by the core LLM's extensive understanding of language patterns and structures, ensuring that the synthetic data maintains the contextual integrity of the original examples while introducing variations that cover a wide range of possible inputs and scenarios. This comprehensive dataset equips the QLoRAs with the ability to generalize effectively during training, enhancing their performance on unseen data.

The QLoRA Training phase involves fine-tuning the adapters using the generated training data. The Trainer employs a fine-tuning process where the QLoRAs are integrated with the core model, for example, one with 1.8 billion parameters. Importantly, during this process, only the parameters of the QLoRAs are updated, while the core model's parameters remain unchanged. This selective training focuses computational resources on adjusting the adapter's weights to capture task-specific patterns and responses, allowing the base model to execute specific tasks with enhanced precision. The fine-tuning utilizes optimization algorithms that iteratively adjust the adapter's parameters to minimize the discrepancy between the model's outputs and the desired outputs defined in the training data.

In some embodiments, to ensure efficient training, the Trainer incorporates advanced Model Optimization Techniques. One such technique is the use of Paged Optimizers, which manage memory usage effectively during the training process, particularly when dealing with large models or extensive datasets. Paged optimizers partition the model's parameters and gradients into manageable pages that are swapped in and out of memory as needed.

Another optimization technique may be employed is Attention Sinks. In transformer-based models, the attention mechanism significantly contributes to computational complexity, especially with long input sequences. Attention sinks simplify or limit the attention computations for certain positions in the sequence, effectively reducing the number of required computations. This can involve clustering tokens or reducing the attention span for less relevant tokens, thereby decreasing the computational burden on the system.

The Trainer component receives specific inputs to generate its outputs. Inputs include structured data from users, such as example scenarios and variables that define the task-specific requirements. Additionally, the Trainer may source data inputs from external data sources to enrich the training examples and provide a broader context for the QLoRAs.

The outputs of the Trainer component are the finely-tuned QLoRAs, each tailored to perform a specific task within the broader operational scope of the EnterpriseGPT system. These adapters encapsulate the task-specific adjustments needed to fine-tune the core language model's output, effectively bridging the gap between general language understanding and specialized task execution.

The Trainer component is a critical element of the EnterpriseGPT system that enables the creation of highly specialized and efficient task-specific language models. Through innovative training methodologies and optimization techniques, such as the generation of extensive training datasets from minimal user input and the employment of paged optimizers and attention sinks, the Trainer ensures that EnterpriseGPT can deliver precise and contextually relevant AI-driven solutions. This comprehensive approach results in QLoRAs that are both high-performing and resource-efficient, ready to be dynamically integrated with the core model to perform specialized tasks in real-world applications.

Another key aspect of this system is the symbiotic relationship between the core model and the QLoRAs. The core model remains persistently loaded in memory, serving as a stable and readily available linguistic foundation. Its constant presence allows the system to respond to tasks promptly without the latency that would be introduced by loading a large model from disk. The QLoRAs, being significantly smaller, are dynamically managed-loaded into memory when a task requires their specific capabilities and unloaded afterward to conserve resources.

This dynamic management is facilitated by the system's architecture, which allows QLoRAs to be integrated with the core model seamlessly. The adapters extend the core model's functionality by adding specialized layers that adjust its output for particular tasks. Since the core model's parameters remain untouched, the integrity of its general language understanding is preserved, while the QLoRAs provide the necessary specialization.

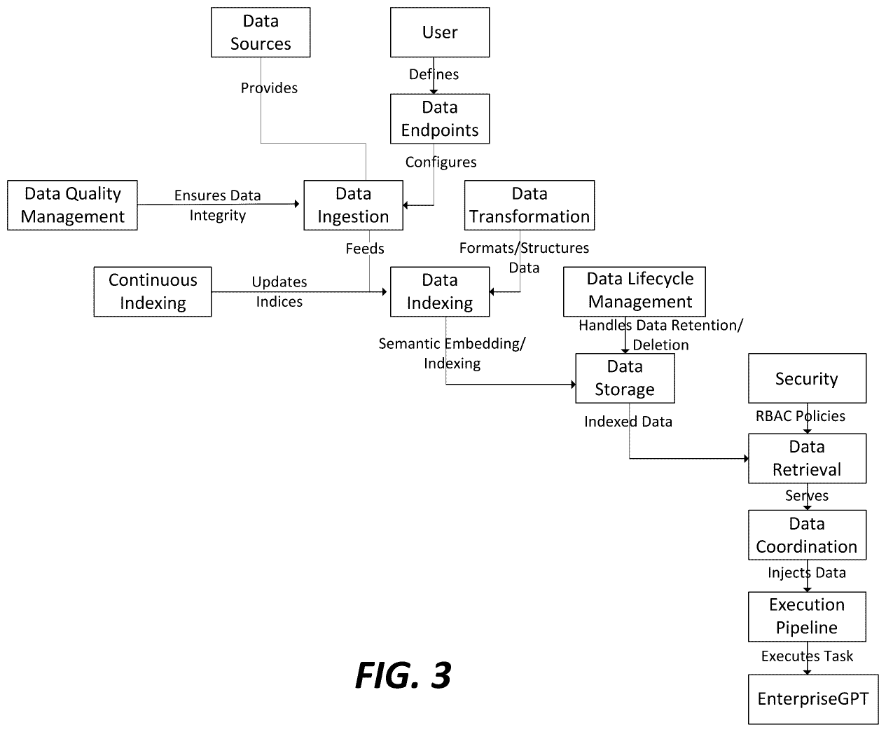

FIG. 3 depicts an example schematic block diagram of a data management architecture, in accordance with embodiments of the present disclosure. The Data Management component is a subsystem within EnterpriseGPT, designed to handle the acquisition, organization, indexing, and retrieval of data necessary for the operation of task-specific language models.

The Data Management component may provide for data ingestion. For example, through data source integration, Data Management component can be capable of integrating with a variety of data sources, including databases, cloud storage, and file systems, through HTTP(S) endpoints defined in the Swagger format. Data normalization enables the Data Management component to normalize incoming data to ensure consistency and compatibility with the indexing and retrieval systems.

Data Management component can provide for data indexing. For example, Data Management component can employ semantic embedding techniques to break down documents into component parts, indexing the vector embeddings for each segment. Data Management component can leverage traditional reverse indexing strategies are also applied to facilitate efficient data retrieval.

Data Management component can provide for data storage. For example, Data Management component can store indexed data in secure repositories, ensuring data integrity and protection.

Data Management component can provide for data retrieval. For example, Data Management component can provide efficient data look-up to facilitate fast retrieval of data, leveraging the indexed embeddings and reverse indexes. Data Management component can provide for dynamic reindexing. For example, as new queries are made, documents can be reindexed to improve the relevance and speed of future searches.

Data Management component can provide for data security. For example, Data Management can enforce RBAC to ensure that only authorized models and users can access sensitive data.

Data Management component uses various inputs and provides various outputs. For example, inputs may include, but are not limited to, Data Descriptors, which are provided by users for data sources and can be used to configure the ingestion and indexing processes; and Data Streams, which can be provided as continuous data streams that can be ingested and indexed in real-time, providing up-to-date information for the system. Outputs may include, but are not limited to, Indexed Data, which is a structured, searchable index of ingested data, ready for retrieval by the Execution component.

The Data Management component of EnterpriseGPT provides for maintaining the flow of information within the system. It ensures that all data is accurately captured, indexed, and stored, allowing for rapid and secure access when needed by the system's language models.

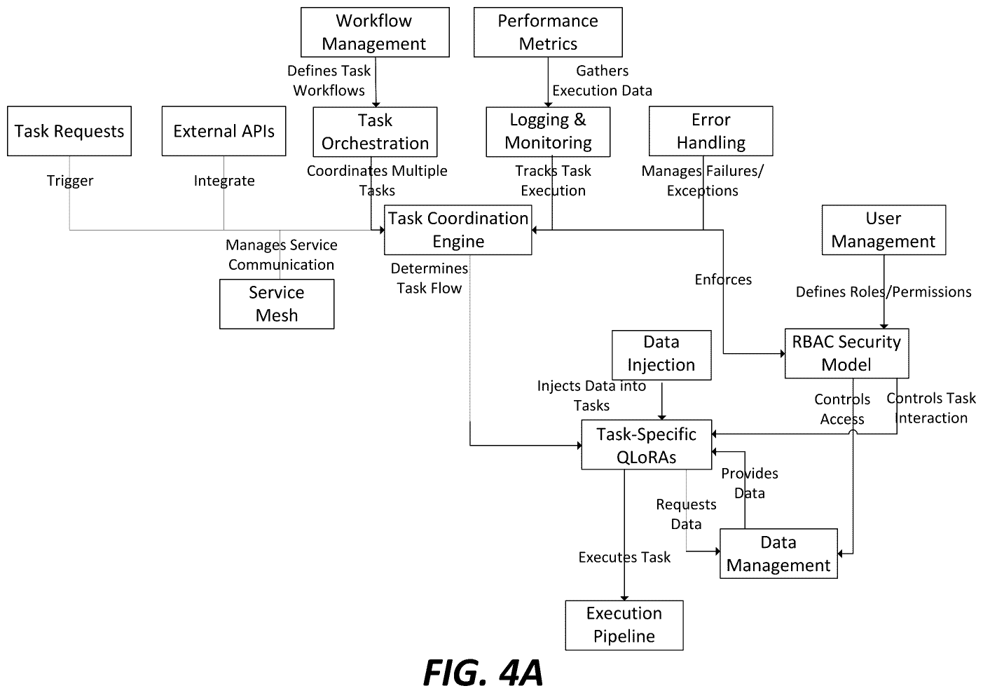

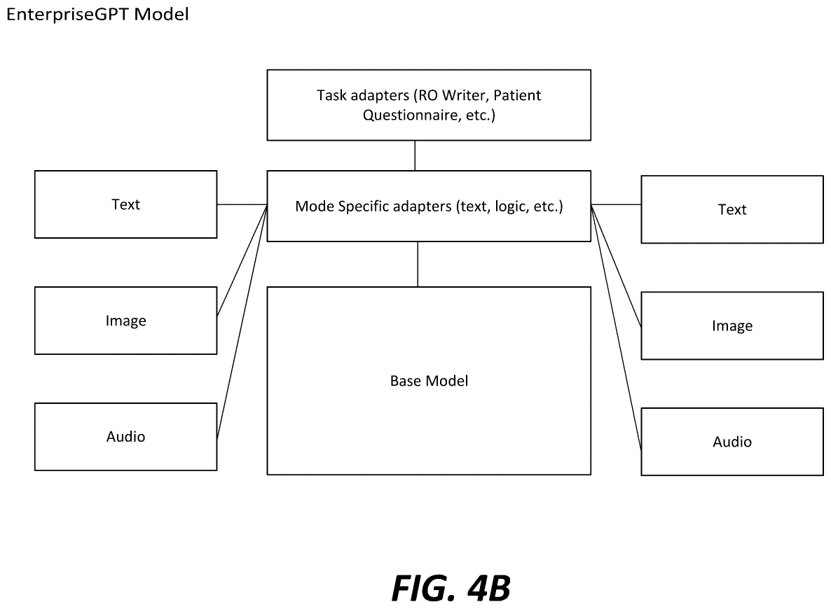

FIG. 4A depicts an example schematic block diagram of a coordination architecture, in accordance with embodiments of the present disclosure. The Coordination component serves as the orchestration layer within EnterpriseGPT, managing the interplay between various task-specific models and ensuring secure and efficient execution of complex, multi-step processes.

Coordination component provides for Task Orchestration. For example, workflow management can be provided that coordinates the sequence and execution of tasks across different QLoRAs and system components, akin to orchestrating the workflow of employees in an enterprise. Coordination component can provider for Dynamic Task Allocation, whereby Coordination component can assign tasks to appropriate QLoRAs based on current system demands and task requirements.

Coordination component can provide for Security and Access Control. For example, Coordination component can implement RBAC to govern how different QLoRAs interact with each other and with data sources, ensuring that each component operates within its designated scope. Coordination component can also provide for data security, by managing secure data flow between tasks, preventing unauthorized access and data leaks.

Coordination component can provide for data injection. For example, Coordination component can employ contextual data integration. Coordination component can be responsible for injecting relevant data from the Data Management component into the execution pipeline, enhancing the accuracy and relevance of task outputs. Coordination component can also provide for data flow management, which can ensure that the right data is available at the right time for each task, optimizing the system's performance.

Coordination component receives various inputs and provides various outputs. Inputs may include, for example but not limited to, task requests, which can be requests received for task execution and may involve multiple QLoRAs and require access to various data source; and security policies, which may include RBAC policies and security rules that define the permissible interactions between different system components. Outputs may include, for example, but not limited to, coordinated task flows, which can be outputs of a streamlined and secure plan for task execution, ensuring that all components work together harmoniously; and security enforcement, which can provide ongoing enforcement of security policies throughout the execution of tasks.

The Coordination component is a part of EnterpriseGPT, akin to the central nervous system of an organism. It can be utilized to ensure that all parts of the system work in concert towards common goals, while maintaining strict security and efficiency standards. This component enables EnterpriseGPT to handle complex, enterprise-level AI tasks with precision and reliability.

FIG. 4B depicts an example system diagram of the EnterpriseGPT model with multi-layer adapters, in accordance with embodiments of the present disclosure.

At the heart of the EnterpriseGPT system lies the Base Language Model, a robust and expansive generative pre-trained transformer (GPT) designed to comprehend and generate human language with high proficiency. This foundational model remains persistently loaded in memory, ensuring immediate accessibility and responsiveness for a wide array of linguistic tasks. Its comprehensive understanding of semantics, syntax, and contextual nuances serves as the bedrock upon which specialized functionalities are built. By maintaining a single, unified base model, the system ensures consistency in language processing while enabling the seamless integration of diverse adapters tailored to specific operational needs.

Enhancing the Base Model's capabilities, Mode-Specific QLoRAs are introduced to bridge various data modalities, facilitating interactions that go beyond plain text. These adapters are meticulously designed to handle different input and output formats, such as audio and images, thereby expanding the system's versatility. For instance, a Text-to-Audio QLoRA enables the conversion of textual content into natural-sounding speech, allowing the system to engage in verbal interactions with users. Conversely, an Image-to-Text QLoRA processes visual data, translating images into descriptive text that the Base Model can further analyze or respond to.

This multimodal integration is visualized in FIG. 4, where the Base Language Model interfaces with multiple Mode-Specific QLoRAs. Each adapter operates independently yet cohesively, ensuring that the system can adeptly switch between different data types without compromising performance or accuracy. By modularizing these capabilities, the EnterpriseGPT system can efficiently manage diverse input streams, catering to varied user interactions and enhancing the overall user experience.

Complementing the Mode-Specific QLoRAs are the Task-Specific QLoRAs, each engineered to execute discrete, specialized functions within distinct operational domains. These adapters are fine-tuned to perform particular tasks with high precision, leveraging the Base Model's linguistic prowess to deliver targeted and contextually relevant outputs. Examples include a Repair Order Writer QLoRA, which generates detailed and accurate repair orders based on input specifications, and a Patient Questionnaire QLoRA, designed to create comprehensive and empathetic patient intake forms.

FIG. 4B illustrates the interplay between the Base Language Model, Mode-Specific QLoRAs, and Task-Specific QLoRAs, highlighting how each adapter seamlessly integrates to fulfill specific operational requirements. The Task-Specific QLoRAs utilize the foundational language understanding provided by the Base Model, applying their specialized training to ensure outputs are not only accurate but also aligned with the unique demands of their respective tasks. This layered approach allows the EnterpriseGPT system to maintain a high degree of specialization and adaptability, enabling it to address a wide range of enterprise needs with remarkable efficiency and effectiveness.

The EnterpriseGPT system in FIG. 4B can further provide for Security and Access Control. For example, Coordination component can implement RBAC to govern how different QLoRAs interact with each other and with data sources, ensuring that each component operates within its designated scope. Coordination component can also provide for data security, by managing secure data flow between tasks, preventing unauthorized access and data leaks.

For example, an interaction session may begin with a user speaking to the system. The audio-to-text adapter converts the user's speech into text and formats it into a proper prompt suitable for the core model's consumption. The core language model, always resident in memory, processes this prompt and generates a textual response. This response is then passed back to the text-to-audio adapter, which converts the text into an audio output. The adapter can personalize the audio response, adding human-like qualities to enhance user experience.

If the user decides to input an image as part of the ongoing interaction, the system responds by dynamically loading the image-to-text adapter into memory. This can be triggered by the user notifying the system of the incoming image upload, either through a voice command or by selecting an option on the system's user interface. The image-to-text adapter processes the uploaded image, generating a textual description or extracting relevant information, which is then fed into the core language model. Depending on the user's accompanying voice instructions, the core model's output may be in the form of text, audio, or even another image. The ability to handle different modalities allows the system to provide versatile responses, catering to the user's specific needs in real-time.

To ensure data privacy and security, especially when dealing with sensitive information, the system incorporates a Personally Identifiable Information (PII) filter adapter as the first layer before any task-specific adapters. The Pll filter adapter is designed to identify and tokenize user-sensitive data within the input. By replacing sensitive information with tokens, it prevents exposure of personal data during processing. When generating prompts for the task-specific adapters, the PII-filtered content ensures that any subsequent processing, even if compromised, does not have access to the raw sensitive data. After the core model generates a response, it is passed back through the task-specific adapters, which may add human-like qualities or further process the output. Finally, the response goes through the PII filter adapter again, which rehydrates the response by replacing the tokens with the original sensitive data. This two-way filtering mechanism maintains data privacy throughout the processing pipeline, safeguarding user information even in the event of a security breach in the downstream adapters.

A practical use case demonstrating the system's multimodal support could involve evaluating the quality of an image-based work product, such as a weld in a manufacturing setting. A user could upload an image of a weld and request an assessment. The image-to-text adapter processes the image, extracting features and generating a textual description. The core language model analyzes this description to evaluate the weld's quality, possibly referencing standards or prior examples. The response could include recommendations or identify defects, which can be converted back into audio or visual formats if needed. This capability can extend to automating warranty processes by assessing product images or handling medical data for triage by analyzing medical images and providing diagnostic suggestions.

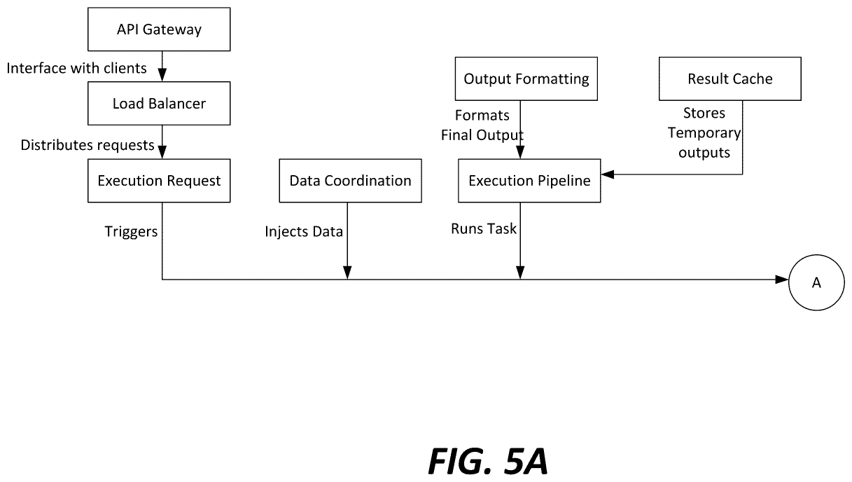

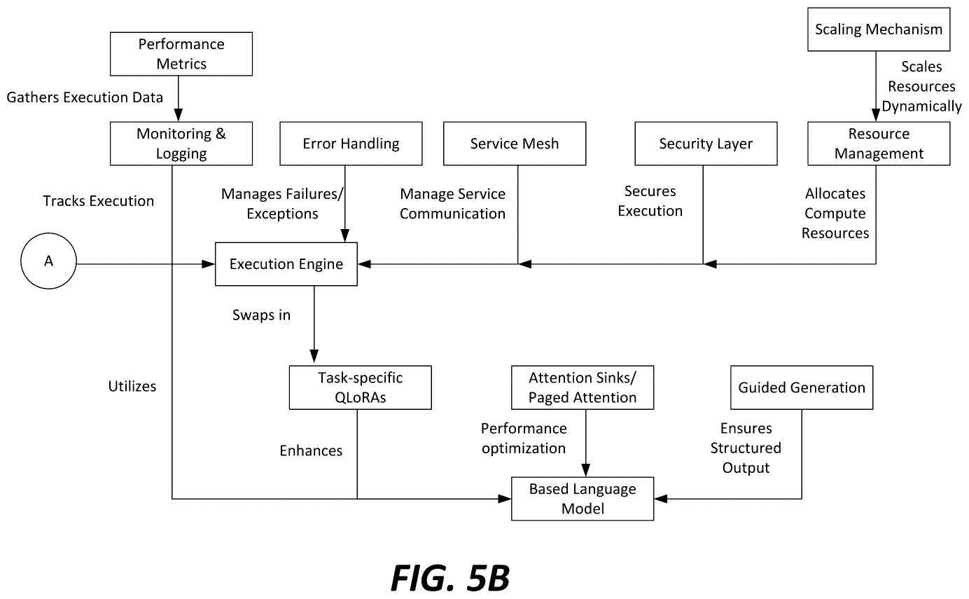

FIGS. 5A and 5B depict an example schematic block diagram of an execution architecture, in accordance with embodiments of the present disclosure. The Execution Pipeline is the operational component of EnterpriseGPT, responsible for the real-time execution of tasks using the fine-tuned QLoRAs. It dynamically manages the deployment of these adapters to process user requests efficiently and accurately.

The Execution Pipeline component may provide for Dynamic Adapter Deployment. For example, Execution Pipeline component can provide for Hot-Swapping of QLoRAs. That is, adapters can be dynamically swapped in and out of the system's memory based on the task requirements, optimizing resource utilization and response times. Execution Pipeline component can also provide for Memory Management. For example, Execution Pipeline component can efficiently manage the system's memory to accommodate multiple QLoRAs, ensuring quick access and task execution.

In some embodiments, each adapter is encapsulated within a module adhering to a standardized interface, which allows for integration with the core language model. This interface defines methods for initialization-preparing the adapter for integration by loading model weights and configurations-and activation, which involves engaging the adapter's functionalities during inference or training. It also includes deactivation procedures to safely disengage the adapter without disrupting ongoing processes, and destruction methods for releasing resources when the adapter is no longer needed.

To manage memory efficiently, the system employs a dynamic loading strategy that utilizes lazy loading and reference counting. Lazy loading ensures that QLoRAs are not loaded into memory until they are required for a task. When a task is initiated, the system checks whether the necessary adapter is already loaded; if it is not, the adapter is loaded from a storage repository (e.g., a local or a cloud storage) into memory. Reference counting keeps track of how many tasks are currently using each adapter. When the reference count drops to zero, the adapter becomes a candidate for unloading. The system continuously monitors overall memory usage and sets thresholds to trigger the unloading of unused adapters, ensuring that memory consumption remains within acceptable limits.

In some embodiments, the hot-swapping process involves several steps. First, the Coordination component identifies the required QLoRA based on the task's context and parameters. If multiple tasks require different adapters simultaneously, the system manages concurrency by allocating separate adapter instances or queuing tasks based on priority levels. Before unloading an adapter, the system ensures that any necessary state or cache information is preserved or transferred, preventing the loss of context in previously completed tasks (e.g., for auditing purposes). Finally, the adapter's resources are safely released, and memory is freed, utilizing garbage collection mechanisms supported by the runtime environment.

The core language model interface includes methods for registering and initializing multiple adapters concurrently. In some cases, the interface includes standardized Application Programming Interface (API) for the plurality of task-specific models. The API provides functionalities to load model weights and configurations, and optionally a counter of task requests being handled by the adapter.

Each adapter may first be recognized by the core interface through a unique identifier or registration process. The interface allows for the initialization of each adapter by loading its model weights and configurations into memory. This ensures that each adapter operates independently while sharing the common resources of the core model. In cases where user tasks require the combined capabilities of multiple adapters (e.g., a user request involving both audio-to-text and text-to-image processing), the core language model interface supports composite adapter chains. The interface can sequentially or concurrently engage multiple adapters, passing intermediate outputs between them as needed. This interaction is facilitated by standardized data structures and protocols that allow the adapters to communicate and operate cohesively within the same session.

In some embodiments, adapters are stored on a local or cloud storage in a serialized format, often using optimized data structures like protocol buffers or custom binary formats to reduce loading times. The system maintains an adapter registry containing metadata about each QLORA, including a unique adapter ID for quick retrieval, compatibility information detailing base model versions and dependencies, and performance metrics that aid in decision-making for loading or unloading adapters.

The Execution Pipeline interacts closely with the Dynamic Adapter Management system. When a new task arrives, the Execution Pipeline queries the adapter registry to determine if the required QLoRA is available and loaded. The system supports parallel execution of tasks using different adapters by leveraging multithreading or asynchronous I/O operations. It also distributes computational load evenly across available resources, taking into account the active adapters and their resource consumption to achieve effective load balancing.

To enhance performance and resource utilization further, the system incorporates several optimization techniques. Given that QLoRAs are quantized, the system is optimized to handle lower-precision computations efficiently, utilizing hardware acceleration where available, such as GPUs with mixed-precision support. Frequently used adapters are kept in a high-speed cache to reduce loading times for recurring tasks. Additionally, the system implements predictive loading by employing machine learning algorithms to anticipate which adapters will be needed soon based on historical task patterns, preloading them to minimize latency.

In some embodiments, the task-specific adapters are assigned different priority levels based on their frequency of use. Adapters that are frequently loaded and used for common tasks are assigned higher priority. Higher-priority adapters are retained in memory for a predetermined period even after it is not being actively used, which ensures that they are readily available for rapid task initiation, reducing the overhead of reloading them from storage. These high-priority adapters remain in memory until a critical memory shortage occurs, at which point even the popular adapters may be unloaded to free up resources for other tasks.

The system's memory management module continuously evaluates the priority levels of the loaded adapters and adjusts the retention strategy based on real-time task demands and memory availability. By maintaining higher-priority adapters in memory, the system optimizes response times for frequent tasks, improving overall performance. This priority-based retention mechanism works in conjunction with predictive loading and cache management to ensure that the most commonly used adapters remain accessible, minimizing latency and enhancing the user experience.

In some embodiments, the prioritization process can be configured to update dynamically, recalculating adapter priority based on changing usage patterns and system performance metrics. This adaptive approach allows the system to respond to shifts in user behavior and task frequency, ensuring that resource allocation remains efficient and aligned with actual operational needs.

In certain use cases, security and isolation are important to the system's design. Each adapter operates within an isolated environment through sandboxing to prevent unintended interactions. The Role-Based Access Control (RBAC) system restricts which tasks or users can trigger the loading of specific adapters, ensuring that only authorized entities have access. Integrity checks validate the adapter files before loading to prevent tampering or corruption, thereby maintaining the system's reliability and trustworthiness.

In some embodiments, the system also includes mechanisms for fault tolerance and recovery. If an adapter fails to load, the system can default to baseline functionality or notify the Coordination component to take alternative actions. Detailed logs are maintained for adapter loading and unloading events, aiding in debugging and system health monitoring. In cases of failure, the system can attempt to reload adapters or switch to backup instances without manual intervention, ensuring minimal disruption to ongoing tasks.

An example workflow illustrates the system's operation. When a user submits a request requiring a specific task, the Coordination component determines the appropriate QLoRA. If the adapter is not already in memory, the system loads it dynamically. The Execution Pipeline then processes the task using the loaded adapter, updating reference counts to reflect the adapter's usage. After the task is completed, the adapter's reference count is decremented. If the count reaches zero and memory thresholds necessitate unloading, the adapter is safely removed from memory.

Execution Pipeline component can provide guided generation. For example, Execution Pipeline component may utilize structured output, whereby the Execution Pipeline component utilizes techniques, such as like Efficient Guided Generation, to ensure that the model's output adheres to specified formats and structures, fulfilling enterprise data contracts. The Execution Pipeline component can also utilize Attention Sinks/Paged Attention. For example, Execution Pipeline component may employ advanced mechanisms to handle large output generation tasks, significantly increasing throughput and reducing latency.

Execution Pipeline component can provide for performance optimization. For example, Execution Pipeline component can provide throughput enhancement, whereby Execution Pipeline component can maximize text output volume and speed, achieving performance rates nearly 9× faster than similar products. Execution Pipeline component can also provide for resource efficiency, for example, by balancing computational load to maintain high efficiency, even when generating extensive text sequences.

Execution Pipeline component can receiver various inputs and provide various outputs. Inputs may include, for example but not limited to, user requests, whereby the Execution Pipeline component receives and processes user requests, determining which QLoRA is best suited for the task; and data inputs, whereby Execution Pipeline component integrates contextual data provided by the Data Management component to inform and enhance task execution. Outputs may include, for example but not limited to, task-specific responses, whereby Execution Pipeline component produces precise and contextually relevant responses to user requests, leveraging the specialized capabilities of the QLoRAs; and performance metrics, whereby Execution Pipeline component generates data on system performance, including response times and resource utilization, to inform continuous optimization.

The Execution Pipeline provides the ability to deliver AI-powered solutions in real-time. With its sophisticated management of QLoRAs and emphasis on structured, efficient output, the Execution Pipeline ensures that EnterpriseGPT can meet the demanding requirements of enterprise-level tasks with unparalleled speed and precision.

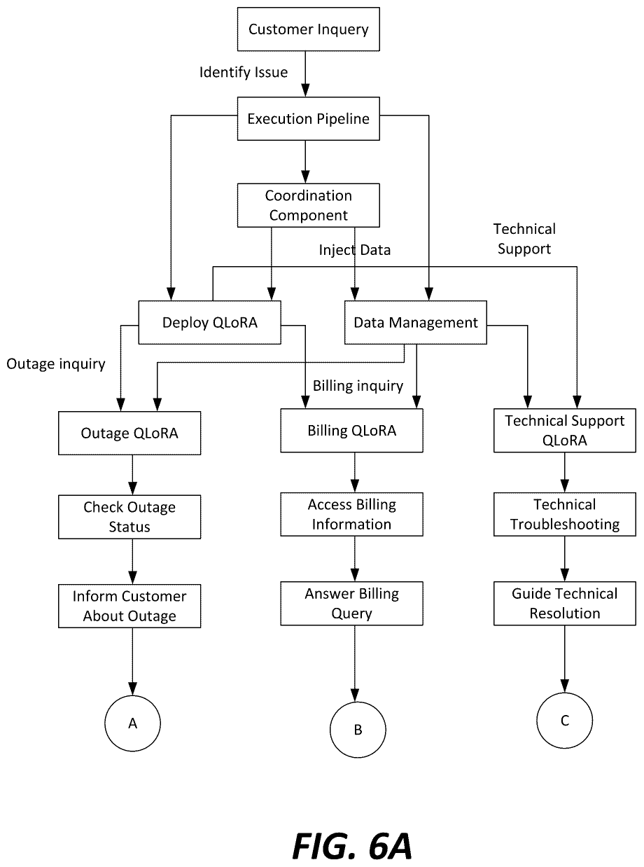

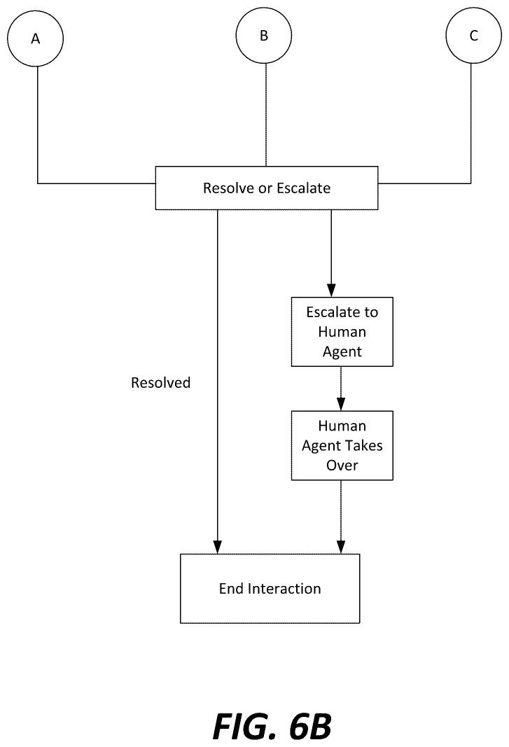

FIGS. 6A and 6B depict an example process flow of a customer service automation use case, in accordance with an embodiment of the present disclosure. This example provides a use case in which embodiments disclosed herein are used for Telecommunications Enterprise Customer Service Automation.

In this example, an enterprise faces challenges with, among other aspects, high volume of customer service calls; diverse issues ranging from simple billing questions to complex technical troubleshooting; need to provide 24/7 support with consistent quality; desire to reduce operational costs and improve customer satisfaction. In view of these challenges, the enterprise may seek to automate responses to common inquiries; efficiently escalate complex issues to human agents; provide personalized customer interactions; maintain data privacy and security.

The embodiments disclosed herein can enable these goals. For example, Trainer Component may provide for custom training. The enterprise may use the Trainer component to create QLoRAs for specific tasks like outage handling, billing inquiries, and technical support. The enterprise may provide a few examples of typical customer interactions for each scenario, and the Trainer generates a vast dataset to fine-tune the QLoRAs. The Trainer component can also provide continuous learning. For example, as new types of inquiries or issues arise, the Trainer updates the QLoRAs with additional training to adapt to the evolving needs.

In this example, Data Management Component can provide data integration. The enterprise integrates its customer database, billing system, and outage management tools with the Data Management component. This can allow the system to pull real-time data to provide accurate information to customers. Data Management component can provide secure indexing. For example, customer data can be securely indexed, ensuring that sensitive information is protected and only accessible as per the defined RBAC policies.

In this example, Coordination Component can provide task orchestration. For example, Coordination component can manage the workflow between different QLoRAs. For example, if a customer starts with a billing question but then moves on to a technical issue, the Coordination component ensures a seamless transition between the billing QLoRA and the technical support QLoRA. Coordination Component can provide data injection. For example, relevant data from the Data Management component is injected into the execution pipeline to provide personalized responses, such as account status or outage updates.

In this example, Execution Pipeline Component can provide real-time execution. For example, when a customer contacts the service center, the Execution Pipeline component quickly determines the nature of the inquiry and deploys the appropriate QLoRA to handle the request. The Execution Pipeline Component can also provide dynamic Response Generation. For example, the system can generate responses that are coherent, contextually relevant, and adhere to the enterprise's communication standards. The Execution Pipeline Component can also provide an escalation protocol. For example, for issues that require human intervention, the system smoothly escalates the case to a human agent, providing all the necessary context for a seamless handover.

In this example, the flow can be as follows. A customer contacts the service center regarding a service outage. The Execution Pipeline activates the outage QLoRA, which checks the Data Management system for any known outages in the customer's area. The QLoRA informs the customer about the outage status and estimated resolution time. If the customer has a follow-up billing question, the Coordination component switches to the billing QLoRA without dropping the interaction. The billing QLoRA accesses the customer's billing information and answers their query. Throughout the interaction, the system ensures data privacy and adheres to the enterprise's security protocols.

Thus, by leveraging EnterpriseGPT, the telecommunications enterprise can automate a significant portion of its customer service operations, providing quick, accurate, and personalized support while freeing up human agents to handle more complex cases. This leads to increased efficiency, reduced operational costs, and improved customer satisfaction.

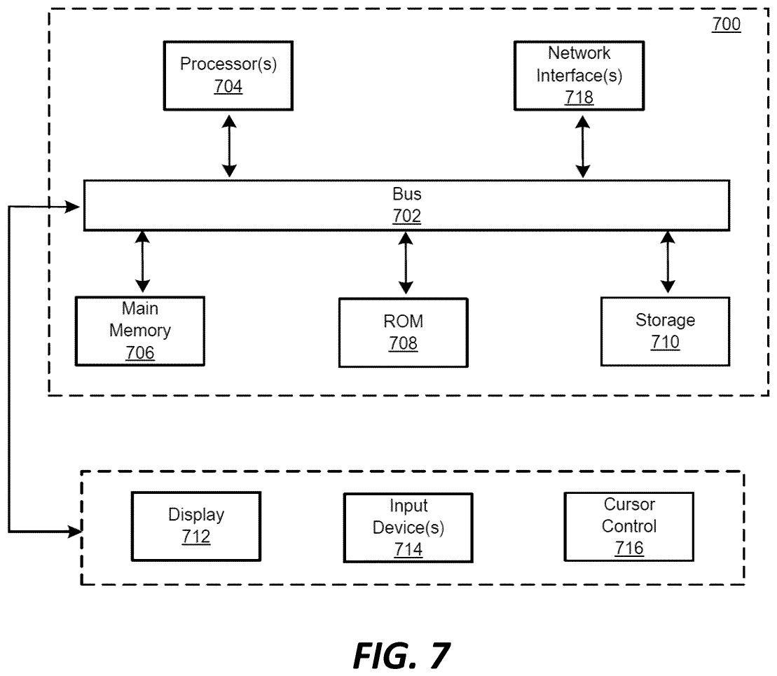

FIG. 7 depicts a block diagram of an example computer system 700 in which various of the embodiments described herein may be implemented. Computer system 700 may be an example implementation of one or more of components of the architectures depicted in FIGS. 1-6B. The computer system 700 includes a bus 702 or other communication mechanism for communicating information, one or more hardware processors 704 coupled with bus 702 for processing information. Hardware processor(s) 704 may be, for example, one or more general purpose microprocessors.

The computer system 700 also includes a main memory 706, such as a random-access memory (RAM), cache and/or other dynamic storage devices, coupled to bus 702 for storing information and instructions to be executed by processor 704. Main memory may store, for example, instructions for executing one or more functions disclosed herein, as well as functions of the architectures depicted in FIGS. 1-6B. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

The computer system 700 further includes a read only memory (ROM) 708 or other static storage device coupled to bus 702 for storing static information and instructions for processor 704. A storage device 710, such as a magnetic disk, optical disk, or USB thumb drive (Flash drive), etc., is provided and coupled to bus 702 for storing information and instructions.

The computer system 700 may be coupled via bus 702 to a display 712, such as a liquid crystal display (LCD) (or touch screen), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. In some embodiments, the same direction information and command selections as cursor control may be implemented via receiving touches on a touch screen without a cursor.

The computing system 700 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 706. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 702. Transmission media can also take the form of acoustic or light waves, such as those generated during radio-wave and infra-red data communications.

The computer system 700 also includes a communication interface 718 coupled to bus 702. Network interface 718 provides a two-way data communication coupling to one or more network links that are connected to one or more local networks. For example, communication interface 718 may be an integrated services digital network (ISDN) card, cable modem, satellite modem, or a modem to provide a data communication connection to a corresponding type of telephone line. As another example, network interface 718 may be a local area network (LAN) card to provide a data communication connection to a compatible LAN (or WAN component to communicated with a WAN). Wireless links may also be implemented. In any such implementation, network interface 718 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the worldwide packet data communication network now commonly referred to as the “Internet.” Local network and Internet both use electrical, electromagnetic or optical signals that carry digital data streams. The signals through the various networks and the signals on network link and through communication interface 718, which carry the digital data to and from computer system 700, are example forms of transmission media.

The computer system 700 can send messages and receive data, including program code, through the network(s), network link and communication interface 718. In the Internet example, a server might transmit a requested code for an application program through the Internet, the ISP, the local network and the communication interface 718.

The received code may be executed by processor 704 as it is received, and/or stored in storage device 710, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALS, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 700.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system, comprising:
a memory;
a persistent storage;
a core model that resides in memory; and
a plurality of task-specific models that reside in the persistent storage and dynamically loadable into and unloadable from the memory in real-time in response to incoming task requests,
wherein:
upon receiving a task request, a corresponding task-specific model is loaded into the memory and plugged into the core model as an additional layer of the core model to fine-tune output of the core model.

2. The system of claim 1, wherein the corresponding task-specific model is unloaded upon completion of the task request.

3. The system of claim 1, wherein the task-specific models are trained with task-specific training data to fine-tune the output of the core model for a specific task,
weights of the task-specific models use reduced bit-depth representation, and
at least one weight tensor of the task-specific models is decomposed as a product of multiple lower-dimensional tensors.

4. The system of claim 1, wherein the core model comprises a standardized Application Programming Interface (API) for the plurality of task-specific models, wherein the API comprises functionalities to load model weights and configurations.

5. The system of claim 1, further comprising one or more processors and one or more non-transitory computer-readable memories coupled to the one or more processors and configured with instructions executable by the one or more processors to:
receive user-provided input data including a task scenario and variables outlining task-specific requirements and expected outcomes;
generate a prompt based on the user-provided input data to a large language model (LLM) for generating synthetic training data set using data augmentation and conditional text generation;
feed the synthetic training data set into the core model to obtain intermediate outputs; and
fine-tune the intermediate outputs by adjusting parameters of a task-specific model corresponding to the task scenario, wherein parameters of the core model remain unchanged.

6. The system of claim 5, wherein to fine-tune the intermediate outputs by adjusting parameters of a task-specific model, the one or more processors are configured to:
partition the parameters of the task-specific model into pages that are swapped in and out of the memory as needed.

7. The system of claim 1, wherein the plurality of task-specific models comprise one or more of an audio-to-text adapter, a text-to-audio adapter, an image-to-text adapter, or a sensitive data filter adapter.

8. The system of claim 7, wherein the sensitive data filter adapter is configured as a first processing layer to identify and tokenize user-sensitive data in an input before forwarding it to other task-specific models.

9. The system of claim 7, wherein the sensitive data filter adapter is further configured to rehydrate outputs from the other task-specific models by replacing tokens with original sensitive data after processing by the core model and task-specific models.

10. The system of claim 7, wherein the sensitive data filter adapter is configured to tokenize sensitive data using predefined data patterns and maintain a mapping for rehydration of outputs from the other task-specific models.

11. The system of claim 1, wherein an interface of the core model is configured to manage memory usage by reference counting to track active usage of the plurality of task-specific models such that task-specific models with a reference count of zero become candidates for unloading.

12. The system of claim 1, wherein the plurality of task-specific models are assigned different priority levels based on corresponding loading frequencies, wherein frequently loaded task-specific models are assigned higher priority, and
a task-specific model assigned with a higher priority is retained in the memory even when not actively in use, ensuring rapid task initiation and reducing overhead of reloading from the persistent storage.

13. The system of claim 12, wherein the task-specific model assigned with the higher priority is unloaded when a memory shortage occurs, freeing resources for other tasks.

14. A computer-implemented method, comprising:
storing a core model in a memory;
storing a plurality of task-specific models in a persistent storage;
loading, in real-time, a corresponding task-specific model from the persistent storage into the memory in response to an incoming task request;
integrating the corresponding task-specific model as an additional layer of the core model to fine-tune output of the core model; and
processing the task request using the core model with the integrated task-specific model to generate a task-specific output.

15. The computer-implemented method of claim 14, further comprising:
unloading the corresponding task-specific model from the memory upon completion of the task request.

16. The computer-implemented method of claim 14, wherein each task-specific model is trained using task-specific training data to fine-tune the output of the core model for a specific task, and wherein the method further comprises:
representing weights of the task-specific models with reduced bit-depth; and
decomposing at least one weight tensor of the task-specific models as a product of multiple lower-dimensional tensors.

17. A non-transitory computer-readable storage medium configured with instructions executable by one or more processors to cause the one or more processors to perform operations comprising:
storing a core model in a memory;
storing a plurality of task-specific models in a persistent storage;
loading, in real-time, a corresponding task-specific model from the persistent storage into the memory in response to an incoming task request;
integrating the corresponding task-specific model as an additional layer of the core model to fine-tune output of the core model; and
processing the task request using the core model with the integrated task-specific model to generate a task-specific output.

18. The non-transitory computer-readable storage medium of claim 17, wherein the operations further comprise:
unloading the corresponding task-specific model from the memory upon completion of the task request.

19. The non-transitory computer-readable storage medium of claim 17, wherein each task-specific model is trained using task-specific training data to fine-tune the output of the core model for a specific task, and wherein the operations further comprise:
representing weights of the task-specific models with reduced bit-depth; and
decomposing at least one weight tensor of the task-specific models as a product of multiple lower-dimensional tensors.

20. The non-transitory computer-readable storage medium of claim 17, wherein the operations further comprise:
receiving user-provided input data including a task scenario and variables outlining task-specific requirements and expected outcomes;
generating, using a large language model (LLM), a synthetic training data set based on the user-provided input data, wherein generating the synthetic training data set includes data augmentation and conditional text generation;
feeding the synthetic training data set into the core model to obtain intermediate outputs; and
fine-tuning the intermediate outputs by adjusting parameters of a task-specific model corresponding to the task scenario, wherein parameters of the core model remain unchanged during the fine-tuning.
